(19) United States
(12) Patent Application Publication
(10) Pub. No.: US 2025/0376403 A1
(43) Pub. Date: Dec. 11, 2025

(54) Restricting Backflowing Molten Glass in a Refiner

(71) Applicant: Owens-Brockway Glass Container Inc., Perrysburg, OH (US)

(72) Inventor: Daniel Landrum, Temperance, MI (US)

(21) Appl. No.: 18/737,411

(22) Filed: Jun. 7, 2024

(51) Int. Cl. C03B 5/225; C03B 5/04; C03B 5/20; C03B 7/06

(52) U.S. Cl. CPC C03B 5/225; C03B 5/04; C03B 5/20; C03B 7/06

(57) ABSTRACT

A refiner for a glass melting system includes a housing that defines a refining chamber and a refining well. The refining chamber contains a refining glass bath, which is fed by a flow of incoming glass that flows through the refiner well. To impede molten glass within the refining glass bath from backflowing into the refiner well, the housing of the refiner includes a backflow restrictor wall that projects upwardly from a floor of the refiner and elevates a refiner well outlet above the refiner floor, and/or the refiner well outlet is defined at least partially by the refiner floor and the refiner well is provided with a rectangular cross-sectional shape that is constant from the refiner well outlet down through the refiner well at least part way to a refiner well floor.

### TECHNICAL FIELD

This patent application discloses innovations related to glass manufacturing and, more particularly, to glass refiners.

### BACKGROUND

A conventional glass melting system in a glass container manufacturing plant typically includes a glass melting furnace, a refiner, and one or more forehearths. The furnace receives a batch material into a melting chamber on top of a molten glass bath. The batch material is a physical mixture of various materials (e.g., sand, soda ash, limestone, cullet, and others materials) that melts over time into molten glass within the molten glass bath while the bath is heated radiantly with overhead combustion burners. Glass that is formed in the melting chamber eventually flows within the molten glass bath out of the melting chamber of the furnace, through a flow conduit of an intervening throat, and into a refining chamber of the refiner where the flow of glass feeds a refining glass bath within the refining chamber. The refining glass bath provides refined molten glass to one or more forehearths, either directly or through a conditioning channel, with each forehearth operating to condition the refined molten glass and to supply the resultant conditioned molten glass to a glass feeder. As part of the process of introducing the batch material into the melting chamber and melting the batch material, gas bubbles may be introduced into the molten glass bath within the melting chamber. These gas bubbles may need to be removed—a process known as “refining” the glass—to some extent to ensure that the glass containers formed from the conditioned molten glass are aesthetically appealing and exhibit a consistent appearance.

The refining process that ultimately results in the refined molten glass takes place in the melting chamber and in the fining chamber. The removal of gas bubbles begins in the high temperature melting chamber as the larger gas bubbles quickly ascend through the molten glass bath and burst when they reach the surface of the glass bath. This process may be assisted by fining agents, which are secondary materials (e.g., sodium sulfate) included in the batch material that become less soluble in glass as the temperature of the glass increases. The gasses released by these fining agents combine with and enlarge existing gas bubbles, thereby increasing the rate at which the enlarged bubbles rise to the top of the molten glass. The concentration of entrained gas bubbles in the refining glass bath is additionally reduced within the refining chamber. In the refining chamber, entrained gas bubbles continue to rise out of the refining glass bath, which is aided by achieving a non-turbulent flow of the bath to promote the timely ascension and escape of the entrained gas bubbles. The refining glass bath is also slowly cooled within the refining chamber as the glass flows towards the forehearth(s). This cooling increases the solubility of certain gasses within the glass, allowing smaller entrained gas bubbles that do not escape the refining glass bath to dissolve back into the glass.

The flow conduit of the throat that connects the melting chamber of the furnace and the refining chamber of the refiner typically extends along an upward angle from the melting chamber to a refiner well of the refiner. The refiner well is the deepest portion of the refiner and has a refiner well outlet provided by an opening in a surrounding floor of the refiner through which molten glass can flow directly from the refiner well and into the refining chamber. The refiner well is typically defined partially by an upstream wall extending in a straight vertically upwardly direction and a downstream wall extending obliquely away from the upstream wall. As molten glass flows through the throat and into the refiner well, a flow of incoming glass rises upwardly through the well, typically along the upstream wall of the refiner well while flowing laminarly, before dispersing outwardly throughout the refining chamber. In some cases, however, molten glass within the refining chamber flows back toward and into the refiner well. This backflowing glass tends to establish a recirculating flow pattern along the downstream wall of the refiner well adjacent to the upwards laminar incoming glass flow. The recirculating flow of relatively colder and more refined backflowing molten glass having a longer residence time in the furnace/refiner may thus mix with the upwards laminar flow of relatively hotter and less refined incoming molten glass having a shorter residence within in the furnace/refiner. The mixing of these different glass flows within the refiner well may create nucleation points and other mixing-related dynamics that can lead to the formation of commercial variations, such as gas inclusions (e.g., “blisters”), in subsequently-formed glass containers.

### SUMMARY OF THE DISCLOSURE

A glass melting system according to one embodiment of the disclosure includes a furnace, a throat, and a refiner. The furnace includes a housing that defines a melting chamber and a furnace glass outlet of the melting chamber. The throat defines a flow conduit that extends from a throat inlet to a throat outlet and the throat inlet is in flow communication with the furnace glass outlet. The refiner includes a housing that defines a refiner well and further includes a refiner floor and a backflow restrictor wall that projects upwardly from the refiner floor. The refiner well has a refiner well inlet, which is in flow communication with the throat outlet, and passes upwardly through the refiner floor to a refiner well outlet that is defined at least partially by the backflow restrictor wall and is elevated above the refiner floor.

A glass melting system according to another embodiment of the disclosure includes a furnace, a throat, and a refiner. The furnace includes a housing that defines a melting chamber and a furnace glass outlet of the melting chamber. The throat defines a flow conduit that extends from a throat inlet to a throat outlet and the throat inlet is in flow communication with the furnace glass outlet. The refiner includes a housing that defines a refiner well and further includes a refiner floor. The refiner well has a refiner well inlet, which is in flow communication with the throat outlet and is partially defined by a refiner well floor, and a refiner well outlet, which is defined at least partially by the refiner floor. The refiner well has a constant rectangular cross-sectional shape from the refiner well outlet down through the refiner well at least part way to the refiner well floor.

A refiner for a glass melting system according to one embodiment of the disclosure includes a housing having a refiner floor, a refiner upstream wall, a refiner downstream wall spaced apart from the refiner upstream wall, and two opposed refiner sidewalls extending between the refiner upstream wall and the refiner downstream wall. Each of the refiner upstream wall, the refiner downstream wall, and the opposed refiner sidewalls extends upwardly from the refiner floor to a refiner roof to establish a refining chamber. The housing of the refiner additionally has a refiner well floor below the refiner floor, a refiner well upstream wall extending upwardly to the refiner upstream wall, a refiner downstream wall extending upwardly from the refiner well floor to the refiner floor, and opposed refiner well sidewalls extending upwardly from the refiner well floor to the refiner floor and extending between the refiner well upstream wall and the refiner well downstream wall. Still further, the housing of the refiner has a backflow restrictor wall that projects upwardly from the refiner floor. The refiner well floor, the refiner well upstream wall, the refiner well downstream wall, the opposed refiner well sidewalls, and the back flow restrictor wall define a refiner well that passes upwardly through the refiner floor and has a refiner well outlet that is elevated above the refiner floor.

A method according to one embodiment of the disclosure includes several steps. One step of the method involves delivering flow of molten glass from a glass furnace outlet of a melting chamber of a furnace. Another step of the method involves receiving the flow of molten glass from the glass furnace outlet into a flow conduit of a throat through a throat inlet and flowing the flow of molten glass along the flow conduit from the throat inlet to a throat outlet. Yet another step of the method involves receiving the flow of molten glass from the throat outlet into a refiner well through a refiner well inlet. The flow of molten glass is directed upwards within the refiner well into an incoming glass flow, and the refiner well is defined by a housing of a refiner and passes upwardly through a refiner floor of the housing of the refiner. Still further, another step of the method involves delivering the incoming glass flow through a refiner well outlet and into a refining glass bath contained within a refining chamber of the refiner with the refiner well outlet being elevated above the refiner floor of the housing of the refiner.

### BRIEF DESCRIPTION OF THE DRAWINGS

FIG. 1 is a cross-sectional view of a glass melting system that includes a furnace, a throat, a refiner, at least one conditioning channel, and at least one forehearth, according to an embodiment of the present disclosure;

FIG. 2 is a longitudinal sectional plan view of the glass melting system illustrated in FIG. 1 taken along section line 2-2;

FIG. 3 is an enlarged fragmentary sectional view of part of the throat and the refiner as shown in FIGS. 1-2;

FIG. 4 is an enlarged fragmentary perspective view of part of the refiner as shown in FIG. 3;

FIG. 5 is an enlarged fragmentary plan view of part of the refiner as shown in FIG. 3;

FIG. 6 is an enlarged fragmentary sectional view of part of the throat and the refiner of a glass melting system according to another embodiment of the present disclosure; and

FIG. 7 is an enlarged fragmentary plan view of part of the refiner as shown in FIG. 6.

### DETAILED DESCRIPTION

A refiner for a glass melting system is disclosed that is structurally configured to curtail the backflow and recirculation of molten glass in a refiner well of the refiner. This ability to impede backflowing glass into the refiner well better preserves the flow of incoming molten glass into the refining chamber and, as a result, helps reduce the occurrence of unacceptable commercial variations within glass containers formed from conditioned molten glass produced by the glass melting system. To impede backflowing molten glass into the refiner well, the refiner includes one or both of the following features: (i) a housing of the refiner includes a backflow restrictor wall that projects upwardly from the floor of the refiner and elevates the refiner well outlet above the refiner floor; or (ii) a particular geometry of the refiner well. Below, the refiner is described in the context of a glass melting system that includes a typical continuous glass melting furnace upstream of the refiner as well as typical glass conditioning equipment downstream of the refiner. However, the refiner may certainly be used with other glass melting and conditioning equipment besides what is shown and described here in detail.

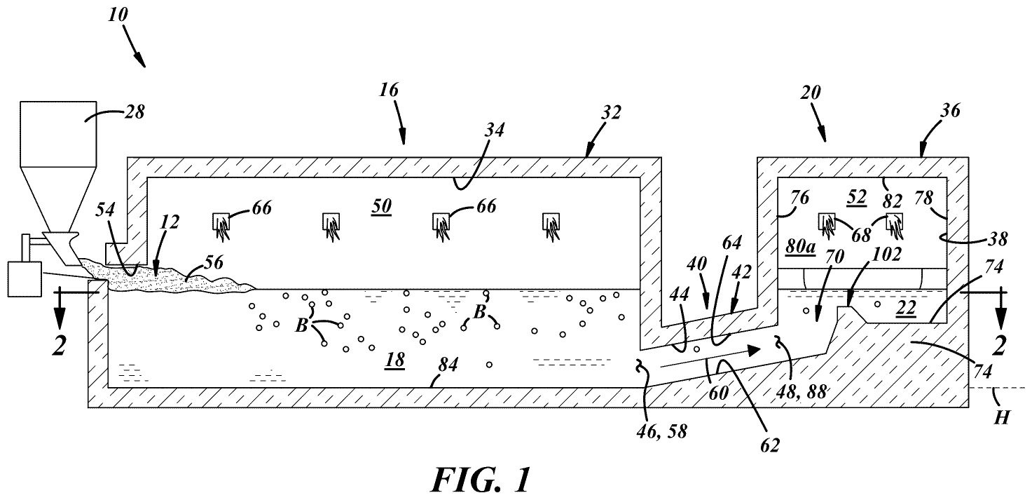

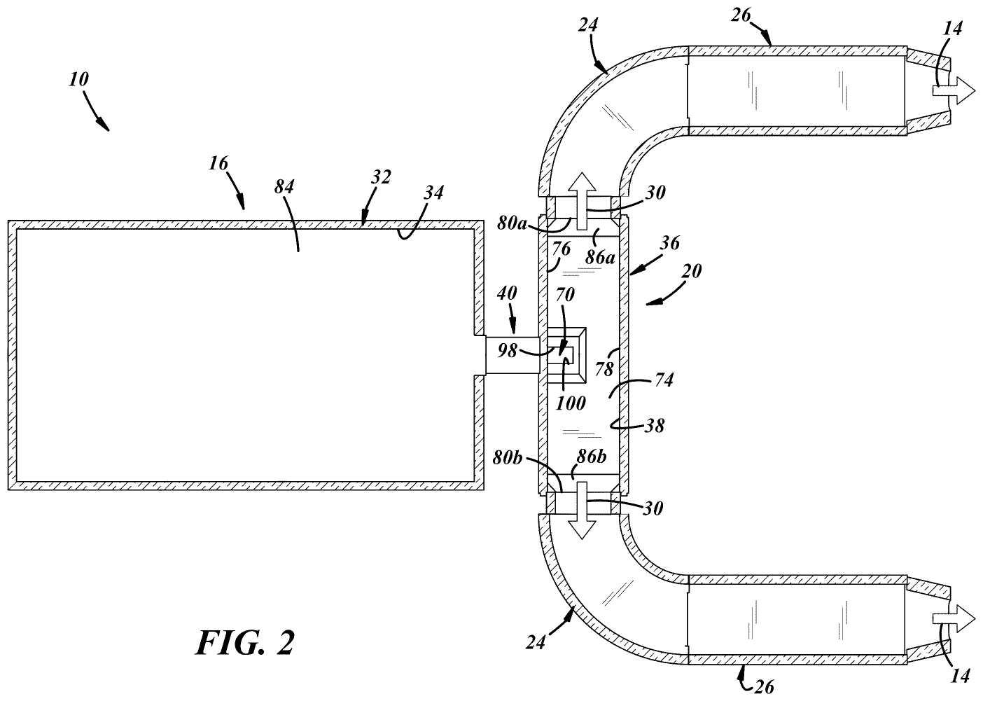

Referring now to FIGS. 1 and 2, an illustrative embodiment of a glass melting system 10 is shown. The glass melting system 10 receives a batch material 12, melts the batch material 12 into molten glass, and delivers conditioned molten glass 14 (FIG. 2) to one or more glass container forming machines (not shown). The glass melting system 10 includes a glass melting furnace 16 that contains a molten glass bath 18, a refiner 20 that is fluidly connected to the furnace 16 and contains a refining glass bath 22, at least one conditioning channel 24, and at least one forehearth 26. The furnace 16 receives the batch material 12 from a batch feeder 28 and the forehearth 26 delivers the conditioned molten glass 14 through a glass feeder (not shown) as a continuous supply of discrete portions of molten glass, each of which is typically referred to as a “glass gob.” In terms of glass flow through the system 10, the refiner 20 is positioned downstream of the furnace 16 and delivers refined molten glass 30 (FIG. 2) to the conditioning channel(s) 24. The refined molten glass 30 contains fewer entrained gas bubbles per unit weight than the glass in the molten glass bath 18 exiting the furnace 16 and is conditioned in each conditioning channel 24 and its associated forehearth 26 to thermally homogenize and adjust the viscosity of the refined molten glass 30 to produce the conditioned molten glass 14. The molten glass bath 18 and, consequently, the refining glass bath 22, are preferably comprised of soda-lime-silica glass, which has a composition that includes 60 wt % to 80 wt % SiO₂, 8 wt % to 18 wt % Na₂O, and 5 wt % to 15 wt % CaO, and thus the batch material 12 is comprised of materials that produce such glass upon melting.

The furnace 16 includes a housing 32 that defines a melting chamber 34 and the refiner 20 includes a housing 36 that defines a refining chamber 38. Additionally, here, a throat 40 is positioned between, and fluidly connects, the furnace 16 and the refiner 20 and also includes a housing 42. The housing 42 of the throat 40 defines a flow conduit 44 that extends from a throat inlet 46 to a throat outlet 48, which is spaced apart from the throat inlet 46, and fluidly connects the melting chamber 34 and the refining chamber 38. The housings 32, 36, 42 of the furnace 16, the refiner 20, and the throat 40 may be constructed from one or more refractory materials and may be part of a single structure. During operation of the glass melting system 10, molten glass partially fills the melting and refining chambers 34, 38 and fully fills the flow conduit 44 of the throat 40. The molten glass bath 18 is contained within the melting chamber 34 and receives the batch material 12 from the batch feeder 28. The refining glass bath 22 is contained within the refining chamber 38 and receives molten glass from the melting chamber 34 through the flow conduit 44 of the throat 40, which is submerged below the levels of the molten glass bath 32 and the refining glass bath 22 and allows for glass to flow from the melting chamber 34 to the downstream refining chamber 38. As the molten glass bath 18 and the refining glass bath 22 only partially fill their respective chambers 34, 38, a melting chamber combustion zone 50 is present within the melting chamber 34 above the molten glass bath 18 and a refining chamber combustion zone 52 is present within the refining chamber 38 above the refining glass fining bath 22.

A batch inlet 54 is defined in the housing 32 of the furnace 16 and provides an entrance into the melting chamber 34 for the delivery of the batch material 12 onto the molten glass bath 18. The batch material 12 is distributed over a section of the molten glass bath 18 as a batch blanket 56 that melts and reacts to form molten glass that mixes into the molten glass bath 18 over time while typically releasing bubbles B into the glass bath 18 as materials in the batch material 12 melt and/or decompose. A furnace glass outlet 58 is also defined in the housing 32 of the furnace 16. The furnace glass outlet 58 is in flow communication with the throat inlet 46 and provides an exit from the melting chamber 34 through which a flow of molten glass 60 can flow out of the melting chamber 34 and into the flow conduit 44 of the throat 40. The flow of molten glass 60 that enters the throat 40 flows from the throat inlet 46 to the throat outlet 48 and feeds the refining glass bath 22 in the refining chamber 38. The housing 42 of the throat 40 may include a throat floor 62 and an opposed throat roof 64, each of which delineates part of the flow conduit 44 and extends from the throat inlet 46 to the throat outlet 48. Preferably, as shown here, the throat floor 62 may be inclined upwardly relative to the horizontal H (the horizontal is level with respect to gravity) from the throat inlet 46 to the throat outlet 48 such that the throat outlet 48 is elevated above the throat inlet 46 and the flow of molten glass 60 moving through the throat 40 flows within the flow conduit 44 along an upwardly angled path. The throat roof 64 may also be inclined upwardly relative to the horizontal H and have the same or different slope as the throat floor 62.

A plurality of overhead burners 66 is mounted in the housing 32 of the furnace 16 within the melting chamber 34. Each of these overhead burners 66 combusts a combustible mixture, which comprises an oxidant and a fuel, and discharges a resultant combustion flame into the melting chamber combustion zone 50 above the molten glass bath 18. These combustion flames heat the molten glass bath 18 to facilitate melting and reacting of the batch material 12 into molten glass. During operation of the furnace 16, and when the molten glass bath 18 is comprised of soda-lime-silica glass, the molten glass bath 18 may be maintained within a temperature range of 1200° C. to 1550° C. Similarly, a plurality of overhead burners 68 may be mounted in the housing 36 of the refiner 20 within the refining chamber 38. Each of these overhead burners 68 also combusts a combustible mixture and discharges a resultant combustion flame into the refining chamber combustion zone 52 above the refining glass bath 22. These combustion flames allow the refining glass bath 22 to cool at a controlled rate to help facilitate the ascension and removal of entrained gas bubbles B from the glass bath 22. During operation of the refiner 20, and when the refining glass bath 22 is comprised of soda-lime-silica glass, the refining glass bath 22 contained within the refining chamber 36 may be maintained within a temperature range of 1150° C. to 1450° C. Moreover, one or both of the furnace 16 or the refiner 20 may also include one or more submerged electrodes to provide Joule heating.

The refiner 20 receives the flow of molten glass 60 from the furnace 16 via the throat 40 and delivers the refined molten glass 30. For example, the refiner 20 may deliver the refined molten glass 30 to each of the forehearths 26 directly or, as shown here, through the intervening conditioning channel 24 such as a refiner alcove. In this example, the glass melting system 10 includes two conditioning channels 24 and two forehearths 26, with each conditioning channel 24 being fluidly connected to the refiner 20 and also being fluidly connected to one of the forehearths 26. Each of the conditioning channels 24 includes an enclosed trough that guides the refined molten glass 30 to the forehearth 26 and may additionally include overhead burners and/submerged electrodes to help retain heat in the glass. Each of the forehearths 26 that are supplied with the refined molten glass 30 from its associated conditioning channel 24 is an elongated structure that establishes an extended trough that extends from a forehearth inlet to a forehearth outlet. And, within each forehearth 26, the refined molten glass 30 received through the forehearth inlet is conditioned into the conditioned molten glass 14 that is discharged through the forehearth outlet, typically by heating and cooling the glass to achieve the forming viscosity (e.g., between 10^{1.5} Pa·s and 10³ Pa·s for soda-lime-silica glass) and to also establish a more uniform temperature profile within the molten glass.

Referring now to FIGS. 1-5, the housing 36 of the refiner 20 defines a refiner well 70 in addition to the refining chamber 38. The refiner well 70 receives the flow of molten glass 60 directly from the throat outlet 48 of the flow conduit 44 and directs the flow of molten glass 60 upwardly into an incoming glass flow 72. The incoming glass flow 72 rises up through the refiner well 70 and enters the refining glass bath 22 contained within the refining chamber 38 to supply the refining glass bath 22 with glass. The housing 36 of the refiner 20 includes a refiner floor 74, a refiner upstream wall 76, a refiner downstream wall 78 spaced apart from the refiner upstream wall 76, opposed refiner sidewalls 80a, 80b extending between the refiner upstream and downstream walls 76, 78, and a roof 82. The refiner floor 74 is preferably elevated above a furnace floor 84 of the housing 32 of the furnace 16. Each of the refiner upstream wall 76, the refiner downstream wall 78, and the opposed refiner sidewalls 80a, 80b extends upwardly from the refiner floor 74 to the refiner roof 82 to establish the refining chamber 38. Also, one or both of the refiner sidewalls 80a, 80b includes a refiner outlet dam 86 over which the refined molten glass 30 flows out of the refiner 20 from the refining glass bath 22. Here each of the opposed refiner sidewalls 80a, 80b includes a refiner outlet dam 86a, 86b, which extends upwardly from the refiner floor 74 in the form of a ramp, as shown, or as a step or other protruding obstacle.

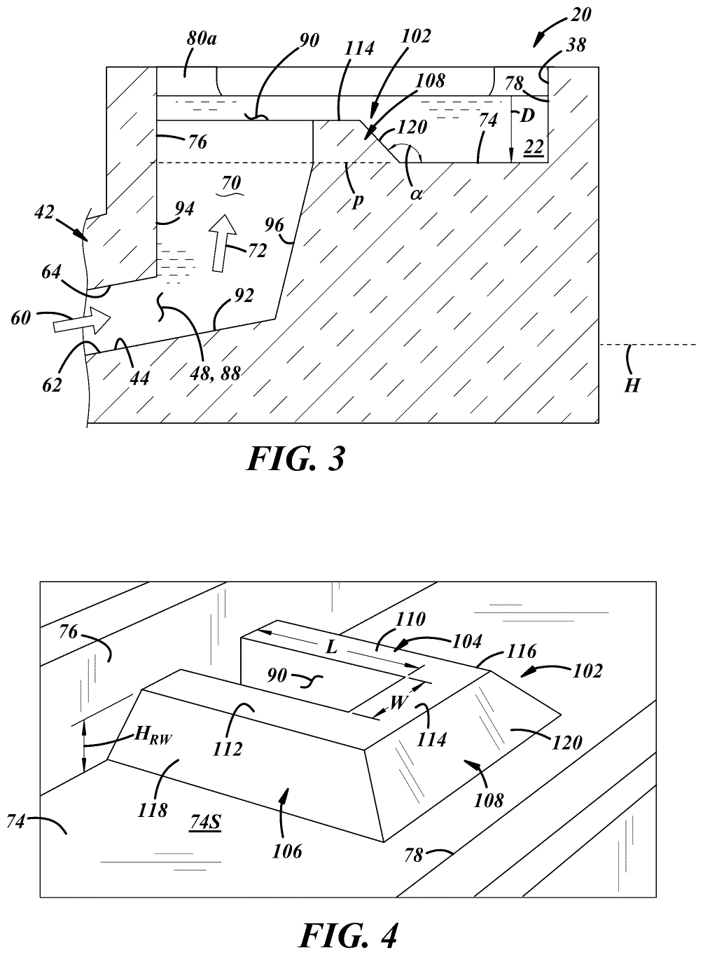

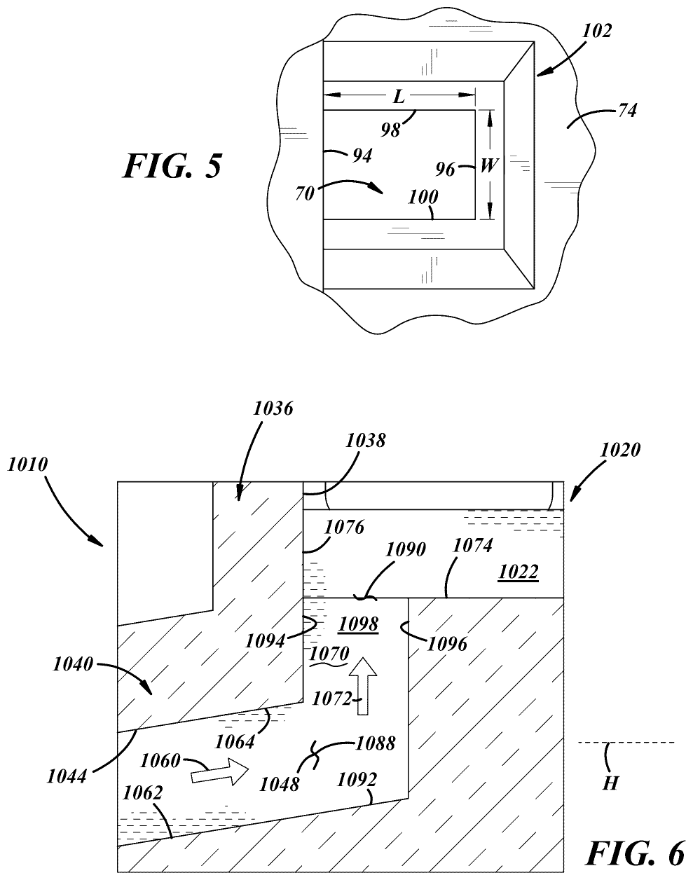

The refiner well 70 has a refiner well inlet 88 and a refiner well outlet 90 as shown best in FIG. 3. The refiner well inlet 88 is in flow communication with and, as shown, may be coterminous with the throat outlet 48. The refiner well 70 preferably passes upwardly through the refiner floor 74 such that the refiner well outlet 90 is elevated above the refiner floor 74 and is provided within the refining chamber 38. To that end, the flow of molten glass 60 is received from the throat outlet 48 and into the refiner well 70 through the refiner well inlet 88, is directed upwards into the incoming glass flow 72, and the incoming glass flow 72 is delivered into the refining chamber 38 through the refiner well outlet 90 after flowing through the refiner well 70. By elevating the refiner well outlet 90 above the refiner floor 74, and particularly the portion of the refiner floor 74 adjacent to and surrounding the refiner well 70, the opportunity for molten glass within the refining glass bath 22 to back flow into the refiner well 70 and recirculate adjacent to the incoming glass flow 72 is mitigated, which helps minimize the occurrence of commercial variations in subsequently formed glass containers that can result from the incoming glass flow interacting with backflowing molten glass. To establish the refiner well 70 and its elevated refiner well outlet 90, the housing 36 of the refiner 20 includes a refiner well floor 92 below the refiner floor 74, a refiner well upstream wall 94, a refiner well downstream wall 96, opposed refiner well sidewalls 98, 100 (FIGS. 2 and 5), and a backflow restrictor wall 102.

The refiner well floor 92 is connected to and extends laterally from the throat floor 62 and partially defines the refiner well inlet 88. Similar to the throat floor 62, the refiner well floor 92 may be inclined upwardly relative to the horizontal H from the refiner well inlet 88 to the refiner well downstream wall 96. The refiner well floor 92 may or may not have the same slope as the throat floor 62. The refiner well upstream wall 94 is connected to and extends upwardly from the throat roof 64 above the refiner well inlet 88 to the refiner upstream wall 76—the two walls 94, 76 meeting at the refiner floor 74, which is indicated by a plane P extending along the refiner floor 74 adjacent to the backflow restrictor wall 102. The refiner well upstream wall 94 may extend vertically upwardly, and thus be oriented perpendicular to the horizontal H, or it may be sloped toward or away from the refiner well downstream wall 96. The refiner well downstream wall 96, which is spaced apart and across from the refiner well upstream wall 94, is connected to and extends upwardly from the refiner well floor 92 to the refiner floor 74. The refiner well downstream wall 96 may be sloped away from the refiner well upstream wall 94, as illustrated, or it may extend vertically upwardly and thus be oriented perpendicular to the horizontal H. The refiner well sidewalls 98, 100 extend upwardly from the refiner well floor 92 to the refiner floor 74 and between the refiner well upstream wall 94 and the refiner well downstream wall 96.

The backflow restrictor wall 102 projects upwardly from the refiner floor 74 to at least partially define the refiner well outlet 90 at an elevated position. The backflow restrictor wall 102 is preferably a continuous wall, without any gaps or breaks, that extends out from the refiner upstream wall 76 and surrounds the refiner well 70. For example, in the embodiment shown here in FIGS. 3-5, the backflow restrictor wall 102 includes first and second opposed flow restrictor sidewalls 104, 106 and a flow restrictor downstream wall 108. Each of the first and second flow restrictor sidewalls 104, 106 extends away from the refiner upstream wall 76 along the refiner floor 74 towards the refiner downstream wall 78 and the flow restrictor downstream wall 108 extends between the flow restrictor sidewalls 104, 106 to render the backflow restrictor wall 102 continuous. The flow restrictor sidewalls 104, 106 may be parallel with each other and the flow restrictor downstream wall 108 may be parallel with the refiner upstream wall 76 so as to form a U-shaped backflow restrictor wall 102. At least one of the first flow restrictor sidewall 104, the second flow restrictor sidewall 106, or the flow restrictor downstream wall 108—and preferably all of the walls 104, 106, 108—may include a planar top surface 110, 112, 114 and an angled exterior side surface 116, 118, 120 that faces the refining chamber 38. The angled exterior sides 116, 118, 120 are sloped away from the refiner well 70; that is, the angled exterior sides 116, 118, 120 form an angle α (FIG. 3) with the refiner floor 74 that is greater than 90 degrees. The backflow restrictor wall 102 is not limited to the shape shown here and, in certain applications, may be non-continuous in that one or more intermittent passages are provided therein.

The backflow restrictor wall 102 may be configured to define and elevate the refiner well outlet 90 to an elevated height H_{RW} (FIG. 3) above the refiner floor 74 to impede the back flow of molten glass into the refiner well 70 since the backflowing glass tends to move towards the refiner well 74 along the refiner floor 74. The elevated height H_{RW} of the refiner well outlet 90—and thus, here, the planar top surfaces 110, 112, 114 of the walls 104, 106, 108 of the backflow restrictor wall 102—may be at least 30% or, more narrowly, at least 40% or even at least 50%, of a depth D of the refining glass bath 22, which is measured from the refiner floor 74 to the surface of the refining glass bath 22 at a location adjacent to the backflow restrictor wall 102. In one particular embodiment, the elevated height H_{RW} of the refiner well outlet 90 may be between 40% and 70% or, more narrowly, between 50% and 65% of the depth D of the refining glass bath 22. For a fairly typical refining glass bath 22, for example, the elevated height H_{RW} of the refiner well outlet 90 may range from 150 mm to 300 mm or, more narrowly, from 200 mm to 250 mm. Additionally, the angle α that each of the angled exterior sides 116, 118, 120 of the walls 104, 106, 108 of the backflow restrictor wall 102, if employed, forms with the refiner floor 74 preferably ranges from 95° to 165° or, more narrowly from 105° to 150°, to help the incoming glass flow 72 more easily flow over the backflow restrictor wall 102 and into the refining glass bath 22 contained within the refining chamber 38.

The area of the refiner well outlet 90 may vary and still accommodate the incoming glass flow 72 without negatively affecting the ability of the backflow restrictor wall 102 to impede backflowing glass from entering the refiner well 70. As shown in FIGS. 4-5, for example, the refiner well outlet 90 has an inner longitudinal length L defined by a distance between the refiner upstream wall 76 and the flow restrictor downstream wall 108, and an inner transverse width W defined by a distance between the opposed first and second flow restrictor sidewalls 104, 106. In one example, the inner longitudinal length L may range from 800 mm to 1000 mm, or more narrowly from 850 mm to 950 mm, and the inner transverse width W may range from 400 mm to 500 mm or, more narrowly, from 420 mm to 480 mm. Additionally, while staying within the aforementioned ranges, a ratio of the inner longitudinal length L to the inner transverse width W may be between 1.6 and 2.5 or, more narrowly, between 1.8 and 2.2. In another example, the inner longitudinal length L may range from 400 mm to 600 mm or, more narrowly, from 450 mm to 550 mm, and the inner transverse width W may range from 400 mm to 600 mm or, more narrowly, from 450 mm to 550 mm. And, while staying within the aforementioned ranges, the ratio of the inner longitudinal length L to the inner transverse width W may be between 0.67 and 1.5 or, more narrowly, between 0.8 and 1.2.

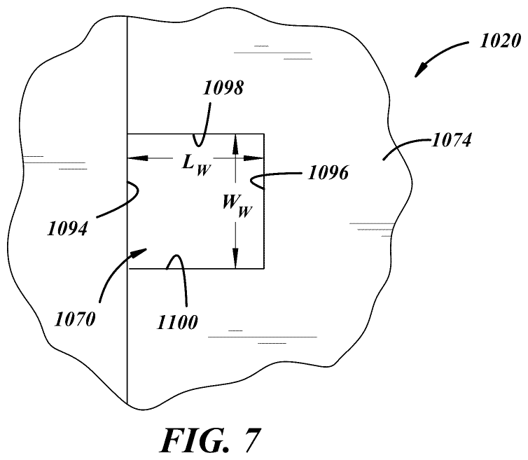

FIGS. 6-7 illustrate another illustrative embodiment of a glass melting system 1010. This embodiment is similar in many respects to the embodiment of FIGS. 1-5 and like numerals between the embodiments designate corresponding features throughout the several views of the drawing figures. Only portions of the glass melting system 1010 that are different from the glass melting system 10 of FIGS. 1-5 are described in detail below. Accordingly, subject matter that is common to the FIGS. 1-5 and FIGS. 6-7 embodiments is generally not be repeated below but is understood to be incorporated into the discussion of FIGS. 6-7 as if fully restated unless specifically indicated otherwise. The glass melting system 1010 shown in FIGS. 6-7 includes a glass finer 1020 that is supplied with a flow of molten glass 1060 through a throat 1040. And, similar to before, the flow of molten glass 1060 flowing through the flow conduit 1044 of the throat 1040 is received into the refiner well 1070 and directed upwards into the incoming glass flow 1072, which ultimately flows through the refiner well outlet 1090 and into the refining glass bath 1022 contained within the refining chamber 1038.

The housing 1036 of the refiner 1070 defines the refining chamber 1038 and the refiner well 1070 as before. However, in this embodiment, the housing 1036 lacks a backflow restrictor wall and, instead, the refiner well outlet 1090 is defined at least partially by the refiner floor 1074. Specifically, here, the refiner well outlet 1090 is defined by the refiner floor 1074 and the refiner well upstream wall 1094. The refiner well 1070 in this embodiment is provided with a geometry that also impedes backflowing glass from entering the refiner well 1070 and recirculating adjacent to the incoming glass flow 1072. As shown, the refiner well upstream wall 1094, the refiner well downstream wall 1096, and the opposed refiner well sidewalls 1098, 1100 provide the refiner well 1070 with a rectangular cross-sectional shape that is constant from the refiner well outlet 1090 down through the refiner well 1070 to at least 40% of a depth of the refiner well 1070, and preferably all the way to the refiner well inlet 1088, with the depth of the refiner well 1070 being measured from the center of the refiner well outlet 1090 straight down to the refiner well floor 1092. Such a constant cross-sectional shape of the refiner well 1070 may be achieved by the refiner well upstream wall 1094 extending vertically upwardly (perpendicular to the horizontal H) from the throat roof 1064, the refiner well downstream wall 1096 extending vertically upwardly from the refiner well floor 1092 parallel to the refiner well upstream wall 1094, and the opposed refiner well sidewalls 1098, 1100 extending vertically upwardly from the refiner well floor 1092 between the refiner well upstream wall 1094 and the refiner well downstream wall 1096 and parallel to one another.

Within the constant cross-sectional shape portion of the refiner well 1070, the well 1070 has a longitudinal well length L_{W}, which is a distance between the refiner well upstream wall 1094 and the refiner well downstream wall 1096, and a transverse well width W_{W}, which is a distance between the opposed refiner well sidewalls 1098, 1100, as shown in FIG. 7. Each of the longitudinal well length L_{W} and the transverse well width W_{W} may range from 400 mm to 600 mm or, more narrowly, from 450 mm to 550 mm, and a ratio of the longitudinal well length L_{W} and the transverse well width W_{W} may range from 0.5 to 1.5 or, more narrowly, from 0.7 to 1.3 or even from 0.8 to 1.2. The specific cross-sectional shape of the refiner well 1070 within the constant rectangular cross-sectional portion may be any quadrilateral shape that satisfies the aforementioned L_{W}:W_{W} ratio constraint. In a preferred implementation, the cross-sectional shape of the refiner well 1070 within the constant rectangular cross-sectional portion is a square shape (ratio of L_{W}:W_{W} of 1) that maintains its constant cross-sectional shape from the refiner well outlet 1090 all the way down to the refiner well inlet 1088. The refiner well geometry of this embodiment may of course be combined with the backflow restrictor wall 102 of the previous embodiment; that is, the refiner well 70 shown in FIGS. 1-5 may assume the geometry of the refiner well 1070 described here in connection with FIGS. 6-7.

As used in herein, the terminology “for example,” “e.g.,” “for instance,” “like,” “such as,” “comprising,” “having,” and “including,” when used with a listing of one or more elements, is to be construed as open-ended, meaning that the listing does not exclude additional elements. Also, as used herein, the term “may” is an expedient merely to indicate optionality, for instance, of a disclosed embodiment, element, or feature. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. As such, many other embodiments, modifications, and equivalents thereto will readily be suggested to persons of ordinary skill in the art in view of the present disclosure and all such variations, even though not necessarily explicitly disclosed, that fall within the scope of the accompanying claims are intended to be embraced by the present disclosure.

1. A glass melting system, comprising:
a furnace including a housing that defines a melting chamber and a furnace glass outlet of the melting chamber;
a throat defining a flow conduit that extends from a throat inlet to a throat outlet, the throat inlet being in flow communication with the furnace glass outlet;
a refiner including a housing that defines a refiner well and that further includes a refiner floor and a backflow restrictor wall that projects upwardly from the refiner floor, the refiner well having a refiner well inlet, which is in flow communication with the throat outlet, and passing upwardly through the refiner floor to a refiner well outlet that is defined at least partially by the backflow restrictor wall and is elevated above the refiner floor.

2. The glass melting system set forth in claim 1, wherein the housing of the refiner further includes a refiner upstream wall that extends upwardly from the refiner floor, and wherein the backflow restrictor wall is a continuous wall that extends out from the refiner upstream wall and fully surrounds the refiner well.

3. The glass melting system set forth in claim 2, wherein the backflow restrictor wall includes first and second opposed flow restrictor sidewalls, each of which extends away from the refiner upstream wall along the refiner floor, and a flow restrictor downstream wall that extends between the opposed flow restrictor sidewalls.

4. The glass melting system set forth in claim 3, wherein at least one of the first flow restrictor sidewall, the second flow restrictor sidewall, or the flow restrictor downstream wall includes a planar top surface and an angled exterior side surface that is sloped away from the refiner well.

5. The glass melting system set forth in claim 1, wherein the refiner well has a refiner well inlet, which is in flow communication with the throat outlet and is partially defined by a refiner well floor, and wherein the refiner well has a constant rectangular cross-sectional shape from the refiner well outlet down through the refiner well at least part way to the refiner well floor.

6. The glass melting system set forth in claim 1, wherein the constant rectangular cross-sectional shape of the refiner well is a square shape.

7. The glass melting system set forth in claim 1, wherein the housing of the refiner further includes a refiner upstream wall, a refiner downstream wall that is spaced apart from the refiner upstream wall, opposed refiner sidewalls that extend between the refiner upstream wall and the refiner downstream wall, and a refiner roof, each of the refiner upstream wall, the refiner downstream wall, and the opposed refiner sidewalls extending upwardly from the refiner floor to the refiner roof to establish a refining chamber within which the refiner well outlet is provided.

8. The glass melting system set forth in claim 7, wherein the throat includes a housing that has a throat floor and an opposed throat roof, each of which delineates part of the flow conduit and extends from the throat inlet to the throat outlet, and wherein the housing of the refiner further comprises:
a refiner well floor below the refiner floor;
a refiner well upstream wall extending upwardly from the throat roof to the refiner upstream wall;
a refiner downstream wall extending upwardly from the refiner well floor to the refiner floor;
and opposed refiner well sidewalls extending upwardly from the refiner well floor to the refiner floor and extending between the refiner well upstream wall and the refiner well downstream wall.

9. A refiner for a glass melting system, comprising:
a housing that includes:
a refiner floor, a refiner upstream wall, a refiner downstream wall spaced apart from the refiner upstream wall, two opposed refiner sidewalls extending between the refiner upstream wall and the refiner downstream wall, each of the refiner upstream wall, the refiner downstream wall, and the opposed refiner sidewalls extending upwardly from the refiner floor to a refiner roof to establish a refining chamber,
a refiner well floor below the refiner floor, a refiner well upstream wall extending upwardly to the refiner upstream wall, a refiner downstream wall extending upwardly from the refiner well floor to the refiner floor, and opposed refiner well sidewalls extending upwardly from the refiner well floor to the refiner floor and extending between the refiner well upstream wall and the refiner well downstream wall, and
a backflow restrictor wall that projects upwardly from the refiner floor, the refiner well floor, the refiner well upstream wall, the refiner well downstream wall, the opposed refiner well sidewalls, and the back flow restrictor wall defining a refiner well that passes upwardly through the refiner floor and has a refiner well outlet that is elevated above the refiner floor.

10. The refiner set forth in claim 9, wherein the backflow restrictor wall is a continuous wall that extends out from the refiner upstream wall and fully surrounds the refiner well.

11. The refiner set forth in claim 10, wherein the backflow restrictor wall includes first and second opposed flow restrictor sidewalls, each of which extends away from the refiner upstream wall along the refiner floor, and a flow restrictor downstream wall that extends between the opposed flow restrictor sidewalls.

12. The refiner set forth in claim 11, wherein at least one of the first flow restrictor sidewall, the second flow restrictor sidewall, or the flow restrictor downstream wall includes a planar top surface and an angled exterior side surface that is sloped away from the refiner well.

13. The refiner set forth in claim 9, wherein the refiner well has a constant rectangular cross-sectional shape from the refiner well outlet down through the refiner well at least part way to the refiner well floor.

14. The refiner set forth in claim 13, wherein the constant rectangular cross-sectional shape of the refiner well is a square shape.

15. A method of melting and refining glass, the method comprising:
delivering a flow of molten glass from a glass furnace outlet of a melting chamber of a furnace;
receiving the flow of molten glass from the glass furnace outlet into a flow conduit of a throat through a throat inlet and flowing the flow of molten glass along the flow conduit from the throat inlet to a throat outlet;
receiving the flow of molten glass from the throat outlet into a refiner well through a refiner well inlet, the flow of molten glass being directed upwards within the refiner well into an incoming glass flow, and wherein the refiner well is defined by a housing of a refiner and passes upwardly through a refiner floor of the housing of the refiner; and
delivering the incoming glass flow through a refiner well outlet and into a refining glass bath contained within a refining chamber of the refiner, the refiner well outlet being elevated above the refiner floor of the housing of the refiner.

16. The method set forth in claim 15, wherein the refiner well outlet is defined at least partially by a backflow restrictor wall that projects upwardly from the refiner floor.

17. The method set forth in claim 16, wherein the refiner well has a refiner well floor below the refiner floor, and wherein the refiner well has a constant rectangular cross-sectional shape from the refiner well outlet down through the refiner well at least part way to the refiner well floor.

18. The method set forth in claim 15, further comprising:
delivering refined molten glass from the refiner to a forehearth;
conditioning the refined molten glass in the forehearth to produce conditioned molten glass; and
forming a glass container from the conditioned molten glass.

19. The method set forth in claim 15, further comprising:
discharging combustion flames into a refining chamber combustion zone above the refining glass bath.

20. A glass melting system, comprising:
a furnace including a housing that defines a melting chamber and a furnace glass outlet of the melting chamber;
a throat defining a flow conduit that extends from a throat inlet to a throat outlet, the throat inlet being in flow communication with the furnace glass outlet;
a refiner including a housing that defines a refiner well and that further includes a refiner floor, the refiner well having a refiner well inlet, which is in flow communication with the throat outlet and is partially defined by a refiner well floor, and a refiner well outlet, which is defined at least partially by the refiner floor, the refiner well having a constant rectangular cross-sectional shape from the refiner well outlet down through the refiner well at least part way to the refiner well floor.

21. The glass melting system set forth in claim 20, wherein the constant rectangular cross-sectional shape of the refiner well is a square shape.
